(19) United States
(12) Patent Application Publication
(10) Pub. No.: US 2024/0114076 A1
(43) Pub. Date: Apr. 4, 2024

(54) System and Method for a Unified Interface to Networked Web Services

(71) Applicant: Polybit Inc., San Francisco, CA (US)

(72) Inventor: Keith Horwood, San Francisco, CA (US)

(21) Appl. No.: 18/379,250

(22) Filed: Oct. 12, 2023

Related U.S. Application Data
(63) Continuation of application No. 16/881,575, filed on May 22, 2020, now abandoned.
Application No. 16/881,575 is a continuation of application No. 15/663,401, filed on Jul. 28, 2017, now Pat. No. 10,701,160.
(60) Provisional application No. 62/367,718, filed on Jul. 28, 2016.

(51) Int. Cl. H04L 67/51; H04L 67/00; H04L 67/10; H04L 67/133

(52) U.S. Cl. CPC H04L 67/51; H04L 67/10; H04L 67/133; H04L 67/34; H04L 67/02

(57) ABSTRACT

A system and method for a function-as-a-service platform that includes creating a set of distinct web services within a web service hosting platform, which involves receiving a web service resource definition, processing the web service resource definition, and instantiating a web service of the web service resource definition within the web service hosting platform; and invoking a web service instantiated in the web service hosting platform for a client device, which involves: receiving a web service function call request, executing the web service function call request on a web service instance, and responding to the web service function call request with a result of the web service.

### CROSS-REFERENCE TO RELATED APPLICATIONS

This Application is a Continuation Application of U.S. patent application Ser. No. 16/881,575, filed on 22 May 2020, which is a Continuation of U.S. Pat. No. 10,701,160, filed on 28 Jul. 2017, and granted on 30 Jun. 2020, both of which claim the benefit of U.S. Provisional Application No. 62/367,718, filed on 28 Jul. 2016, all of which are incorporated in their entirety by this reference.

### TECHNICAL FIELD

This invention relates generally to the field of developer tools, and more specifically to a new and useful system and method for a unified interface to networked web services.

### BACKGROUND

There are a wide variety of tools and resources available to developers. In recent years, application programming interfaces (APIs) have grown in popularity not just as a way of accessing functionality but as a “product” offered by businesses and services. Consumers of outside APIs can benefit by leveraging functionality built and managed by others within their own applications and services. However, the approach to providing an API or any programmatic interface is highly fractured with numerous API standards in use. This can be burdensome to API consumers in that they must customize how each API is integrated into their product or service. At the same time, it can be time consuming and resource intensive for an entity to provide an API. In particular, the complexity of standing up infrastructure to support an API can deter smaller developers and/or open-source developers from offering an API. Thus, there is a need in the developer tool field to create a new and useful system and method for a unified interface to networked web services. This invention provides such a new and useful system and method.

### BRIEF DESCRIPTION OF THE FIGURES

FIG. 1 is a schematic representation of a system of a preferred embodiment;

FIG. 2 is a flowchart representation of a preferred embodiment method;

FIG. 3 is a representation of an exemplary web service definition;

FIG. 4 is a schematic representation of exemplary usage of a command line interface;

FIG. 5 is a schematic representation of exemplary usage of a browser interface; and

FIGS. 6 and 7 are schematic representations of variations for managing web service instance scaling according to combined usage.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for a unified interface to networked web services of a preferred embodiment functions to provide a streamlined approach that enables access to a wide variety of programmatic and/or computational services. The system and method can be used to provide a function-as-a-service (FaaS) offering, wherein functionality across a wide variety of services can be made easily accessible and scalably offered to those wishing to consume that web service. The system and method enable sets of functionalities to be developed and deployed as a web service to a FaaS platform.

The system and method can preferably address creation of services, adapting existing services for a unified interface, discovery of services, the usage of services by other entities, monetization and management of service usage, and/or management of hosting services.

The system and method provides an alternative approach to how programmers traditionally offer developer tools. The web service functionality of a first variety can be routines and services that may otherwise be offered through traditional APIs. For example, a third party may utilize the FaaS platform as an abstraction layer on top of a traditional API (e.g., a REST API). A developer can then easily utilize the web service functionality within the FaaS platform through a unified interface and the developer can be alleviated of the complexity of learning the details of how to interface with the traditional API of the third party. The web service functionality of a second variety may provide static or dynamic processing routines. This functionality may have traditionally been distributed through various packages and libraries that a developer would have to install and/or import. These would have to be updated and individually managed on each device. Through the system and method, programmers can more easily utilize these processing routines by using the unified interface approach and without having to manage various libraries and/or packages. Simplification of an application's library and package dependencies, which may be enabled through the system and method, may make that application more portable to other computing environments.

A web service as used here can characterize any collection of computational functionalities. A web service will generally provide a focused and fine-grained set of functionalities as a form of microservice. A web service is also generally coupled, integrated, or used by other web services or systems. Other services, applications, or systems can be described as consuming a web service to perform some tasks. A web service may alternatively provide any suitable scope of functionality and may, for example, offer numerous distinct sets of functionalities. A web service is preferably responsive to a set of input parameters. Some instances of a web service may generate output parameters. Additionally or alternatively, triggering of a web service may result in some action taken by the web service. A web service of a preferred implementation is a single function with a clear interface protocol that can be executed within an event-driven computing service. In one example, a web service is a node.js function with a number of required and/or optional input parameters and a set of output parameters. However, a web service can be defined using any suitable language, framework or form of run-time environment. That computing service may use a computing execution model where the provider dynamically manages resource allocation as a way of providing “serverless computing”. Alternatively, persistent computing resources may be allocated for different web services for multiple events and/or for a sustained window of time.

As a first potential benefit, the system and method can abstract the development of an API service away from infrastructure challenges, developer tool development, and/or other challenges that must be addressed beyond the core functionality of a service. Thus, developers wishing to provide an API or distribute their code can simply deploy their code to the FaaS as a network accessible web service. Infrastructure management can be automatically handled by the FaaS. For example, a web service deployed to the FaaS system can automatically be accessible through a command line interface (CLI), a software development kit (SDK), various device libraries, an application layer-based application programming interface (API) (e.g., a REST API), a graphical web-interface, and/or any other forms of interfaces offered by the FaaS.

As a second potential benefit, the system and method enable a streamlined approach to leveraging functionality offered through the FaaS platform. Consumers of APIs can easily begin using a wide variety of services by using the programmatic interface of the FaaS. Preferably, a developer can leverage functionality by first establishing use of the FaaS (e.g., by including a standard library of the FaaS, installing a command line tool, and/or by specifying the domain of the FaaS) and then using a namespacing syntax to call selected web services through the FaaS platform. In some ways, the FaaS platform can act as the standardized library or tool for programmatically interfacing with network enabled-web services. This may increase speed of development and may enable easier experimentation with new web services.

As another potential benefit, the system and method may provide help and documentation support, web service search and discovery, auto-correction or automatic suggestions for a web service function call, and/or other developer support tools. In a documentation support variation, automatically generating documentation that can be conveniently invoked during development. For example, supported input parameters of a web service function call could be enumerated using a documentation command of a CLI to the FaaS. In a search and discovery variation, functionality queries can be used in browsing and identifying an appropriate web service to meet some functionality goal. In some variations, a generic interface may be used in invoking a web service and the FaaS facilitates selection of the underlying web service from a set of possible web services.

As another potential benefit, web services deployed to the FaaS platform can have automatically enabled analytics, scaling, and support for various developer tools and client interfaces (e.g., command line, web, SDK, etc.). As a system and method designed to host multiple web services, the scaling of computing infrastructure and instantiation of web services can dynamically adapt based on predicted usage.

As another potential benefit, the system and method can provide a unified platform for web service discovery. Discovery of web services and usage instructions/documentation may even be integrated into the various interfaces used in accessing the web services, which can function to make use of new web services more accessible. In some instances, generic interfaces may be used to selectively invoke one of a set of possible web services. This may promote standardization of interfaces.

As an exemplary use case, a company may develop a set of functionalities following guidelines of the FaaS platform. The functionality may interface with an outside computing platform of the company. For example, the functionality may enable access to information about a user on a social network, or submit a media file for some action on a third-party platform, and/or any suitable action. The functionality may alternatively be a processing routine that acts on input data without depending on outside network-accessible resources. The functionality is deployed to the FaaS platform as a web service. Developers wishing to use this web service can then call the web service through the unified interface of the FaaS platform. Furthermore, any other web service deployed on the FaaS platform can also be called through the unified interface. Access to the set of web services on the FaaS platform can further be achieved using a single dependency to the FaaS platform. A rich set of functionalities is then opened up to any network-connected device.

### 2. System

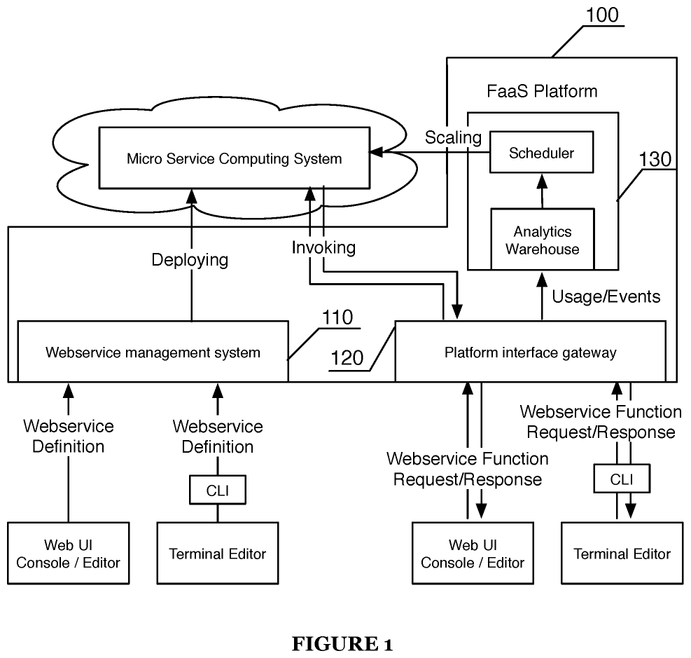

A shown in FIG. 1, a system for a unified interface to networked web services of a preferred embodiment is preferably implemented as a FaaS platform 100 that includes a web service management system 110, a platform interface gateway 120, and an infrastructure management system 130. The system is preferably deployed as a multitenant computing platform. As a multitenant computing platform, multiple distinct entities can independently create, deploy, or consume web services offered through the FaaS platform 100. Herein, the system is generally referred to as a FaaS platform 100, but the system may alternatively be implemented as a single tenant computing architecture or alternative architecture and not offered “as a service”. Through the FaaS platform 100, the system functions to enable a first entity to create and make available the use of a web service, and to enable a service, application, or other system to invoke the use of that web service.

An account system can enable entities to create and manage web services deployed to the platform and/or optionally use web service offered by the FaaS platform 100. Various third-party services, developers, and other entities use the system to offer programmatic interfaces to their customized web service. Similarly, consumers of the system can leverage the provided functionality seamlessly in their services, devices, or applications.

The FaaS platform 100 preferably supports a number of interfaces. A unifying syntax can be used by each interface in using the web services. The unifying syntax can offer uniformity and consistency to interactions with the web services. Interfaces to the FaaS platform 100 can include a command line interface, a web interface, an HTTP API interface, various SDK interfaces, and/or other suitable interfaces. The web interface can preferably work on a desktop computer, a mobile computer, or any suitable browser.

The Web service management system 110 of a preferred embodiment functions as system that manages creating, editing, updating, or otherwise setting up the offering of a web service. A developer will preferably provide some definition of a web service to the Web service management system no. When a web service is ready, the developer or managing account can push a version of the web service for deployment. The Web service management system no will process that deployment request and deploy the web service through the infrastructure management system 130 if successful. A web service definition is preferably a function definition and a configuration definition. A function definition is preferably code that specifies how one or more functions are executed when called. The configuration definition can provide information about the web service such as its name, permissions, policies, customized settings, documentation, and/or other properties.

In one example, initializing a new web service will create a web service project that includes a functions directory, a package configuration file, an environment configuration file, and a documentation document. The functions directory can include one or more function files that can contain application logic or scripts used to define functions and other functionality. The package configuration file can be used to specify the name of the service, the version number, a description, author, specify the main entry point of the service, specify any dependencies, set deployment options, and set other configuration properties. The environment configuration file can be used to define various execution environment variables. The documentation document can be used in specifying documentation and information about the web service. The web service definition may additionally adhere to one of a set of web service semantics. The web service semantics could follow various patterns and protocols so that aspects of the web service can be interpreted through the semantics used in defining the web service. For example, comments may be used in specifying input parameters and their expected type. This may be used in generating documentation and type checking during use of the web service. Comments, variable or function naming conventions, and/or other semantics used in the logic for defining a web service may be analyzed for particular patterns that denote some meaning that can then be automatically applied at the interface gateway to such a web service by a compatible computing platform. Such web service semantics may be targeted for serverless computing environments, where web service semantics can be applied towards promoting standard calling conventions (e.g., HTTP), type safety, enforced documentation, background execution, rate limiting, authentication, and/or other features. This could additionally be used in other suitable computing environments such as the ones discussed herein.

The system may additionally include a web service development environment, which may be web console, an application, an IDE plugin or any suitable application. The function development environment preferably facilitates creation and deployment of a web service. The web service management system 110 preferably interfaces with the web service development environment in receiving or updating web service definitions. A developer may alternatively use his or her own tools in developing a web service definition. In one example, a web service may be synchronized with a version-controlled repository, which may be hosted as a remote repository on a hosting platform or a locally managed repository.

The web service management system 110 can additionally handle compilation and transformation of the web service definition, installation of required packages, internal registration of the web service (e.g., setting web service name and id), and/or other tasks used in preparing the web service for use. In particular, the Web service management system 110 prepares for deploying a web service to a web service computing infrastructure.

The platform interface gateway 120 of a preferred embodiment handles function call requests made to a web service. Function calls made through an interface are directed to the gateway 120 where the gateway 120 processes the requests. The platform interface gateway 120 is configured to determine web service routing, to transform the function call to a suitable format for a web service instance of the web service, and to track usage. The FaaS platform 100 preferably supports at least one programmatic interface used in accessing a web service. Supported interfaces can include a command line interface, an SDK, a library interface, an API (e.g., REST API), a web interface, and/or any suitable type of interface. Supported interfaces may additionally include function packaging for third party platforms such as messaging application integrations or digital assistant integrations. In some variations, the platform interface gateway 120 can be compatible to one or more sets of defined web service semantics. Type checking and inferencing, rate limiting, authentication, and/or other aspects specified through the web service semantics can be enforced through the platform interface gateway 120.

The platform interface gateway 120 can additionally support providing documentation through one of the interfaces. For example, function call syntax and input parameter options can be provided by requesting web service usage instructions. Similarly, the platform interface gateway 120 may provide web service discovery and/or automatic selection. In a discovery variation, an interface or other suitable browsing interface can be used in querying for a particular type of web service. Automatic selection may be used in interpreting intent of a function call, selecting an appropriate web service, and translating the intent to an invocation of the selected web service.

The platform interface gateway 120 may additionally include a caching system that can dynamically cache web service responses. In one variation, the caching system analyzes the web service definition and/or usage to determine if and when caching should be used.

The platform interface gateway 120 can additionally include a metering system that tracks usage of a web service. Collected usage data may be used in generating billing, limiting or otherwise restricting usage, dynamically adjusting infrastructure management, reporting on usage, and/or performing any suitable action. In one variation, a developer of a web service can setup paid usage of the web service. Usage of that web service can be tracked by authenticated users making the request. Various usage metrics and billing practices could be applied in generating a bill for the users of the web service.

The infrastructure management system 130 of a preferred embodiment manages a deployed web service. In one variation, a web service cloud is hosted on an outside third party distributed computing infrastructure. The infrastructure management system 130 in that variation coordinates and manages the outside cloud. In one implementation, a serverless computing platform may be used to execute an instance of a web service on-demand in response to a web service request. In another variation, at least a portion of the web service cloud is internally managed in the FaaS platform 100. The infrastructure management system 130 in that variation can directly manage the web service computing resources used in executing instances of the web service to service some request to the web service. Self-managed computing resources may enable enhanced control over dynamic allocation of web service instances. In another variation, the FaaS platform 100 may use a hybrid approach where internal/managed computing resources can be used for a subset of web services and third-party computing resources for serverless execution used for another subset of web services or requests.

The infrastructure management system 130 preferably manages current demand for web services, which can involve instantiating a web service instance to handle current requests. The infrastructure management system 130 can additionally manage proactive, predictive computing allocation for web services. Preferred forms of predictive allocation can include predicting based on temporal usage, regional usage, and/or combined web service usage. In some scenarios, different web services are frequently used in combination. This combined usage of web services may be addressed in the management of computing resources. In one variation, a first web service will internally call a second web service—accordingly, usage of the first web service could result in usage of the second web service. In another variation, an outside system may commonly use two or more web services—accordingly, use of one web service by the outside system could be an indicator for use of another web service. Management of the web services can involve proactively allocating a web service instances (or deallocating), regionally distributing web services (e.g., to minimize network latency), setting up shared computing resources, and/or taking any suitable action for combined usage of web services. In the case where the first web service sometimes depends on a second web service, the infrastructure management system 130 could instantiate both web services in the same computing resource and reroute calls to the second web service directly to the computing resource. This can avoid unnecessary network traversal. The infrastructure management system 130 may additionally support other execution related tasks of the system.

### 3. Method

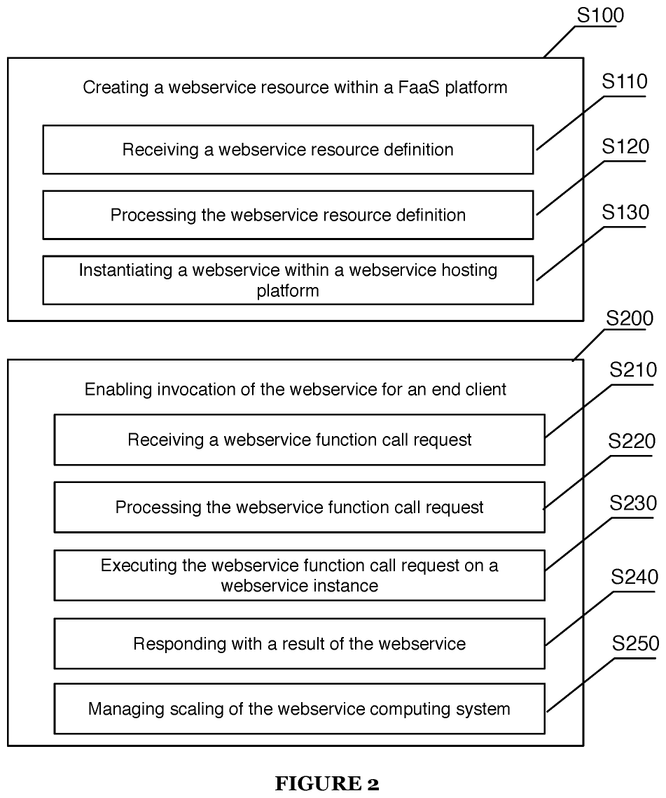

As shown in FIG. 2, a method for a unified interface to networked web services of a preferred embodiment can include creating a web service within a FaaS platform S100 and enabling invocation of the web service resource for an end client S200. Creating a web service resource within a FaaS platform S100 preferably includes receiving a web service resource definition S110, processing the web service resource definition S120, and instantiating a web service within a web service hosting platform S130. Enabling invocation of the web service for an end client preferably includes receiving a web service function call request S210, processing the web service function call request S220, executing the web service function call request on a web service instance S230, and responding with a result of the web service S240.

The method is preferably implemented by a FaaS platform as described above, but any suitable system may alternatively be used. As a FaaS platform, the method is preferably implemented as a multitenant platform where different accounts can individually create one or more web services that may be used, invoked, and consumed by other entities. In one preferred implementation, a multitenant specific implementation of creating a web service can include creating a set of web services within a web service hosting platform that comprises for each web service: receiving a web service resource definition from an account entity of the web service hosting platform, processing the web service resource definition, and instantiating a corresponding web service. As a result, multiple web services can be established on the FaaS platform, which promotes an ecosystem of web services accessible through the FaaS platform. An account entity may manage one or more web services. The invoking a web service will involve the receiving of a specified web service function call request, processing the web service function call request, executing the web service function call request on a web service instance, and responding with a result of the web service. This invocation of the web service may be performed by a variety of entities depending on the permissions and settings of the web service. Anonymous entities and services may call the web service. Alternatively, usage may be restricted or limited to authenticated entities. While the web service may be used by the same entity as the creator, in many scenarios, the web service will be used by other entities.

Block S100, which includes creating a web service within a FaaS platform, functions to enable third party platforms and/or outside developers to offer a set of functionalities through the FaaS platform. The web service can perform any suitable task. In some instances, the web service is an abstraction to third party platform interactions that are also offered over a traditional API. For example, a third-party platform (e.g., social network, SaaS platform, etc.) may build a web service as a proxy interface into their external platform. This can make the third-party platform accessible through a web service of the FaaS platform. In one variation, the web service may be used to offer the only externally exposed interface into a third-party platform. For example, a developer wanting to quickly enable an API to their system can build a web service to facilitate this, and then documentation, CLI support, SDK support, various libraries could automatically be made available by being a web service on the FaaS platform. In other instances, a web service may perform some processing routine such as transforming data, analyzing data, recording data, and/or any suitable routine. For example, the web service may take some input data and calculate a transformation of that data and return the result as the response. In one variation, the processing routine can use one or more outside services, which could include accessing external services (e.g., a social network platform) and/or calling another web service. In another variation, the processing routine can be fully defined through the logic of the web service (e.g., no outside service is used). A web service preferably includes at least one function but may include a set of functions and/or resource definitions.

A developer will preferably register an account with the FaaS platform. A developer account may set various options for how a web service is managed by the FaaS platform. One option could include privacy settings. A web service may be offered as a public function wherein anyone can use the function. Alternatively, a web service could be private or set with limited access permissions. A web service could additionally include account collaboration options wherein other developer accounts could be granted different permissions for the web service resource. Various features and options of a web service may be enabled based on the type of account (e.g., a free account or a paid account). As another aspect, a developer could configure billing options for the web service. The billing options may enable a developer to easily enable monetization of a web service by setting billing rate and billing events. In one implementation, a developer could set highly customized billing options. For example, one developer may bill per request and another developer may bill based on usage rate. Alternatively, a limited set of billing options may be enforced by the FaaS platform.

Block S110, which includes receiving a web service definition, functions to retrieve instructions on how a web service should operate. A web service definition is preferably one or more data objects. Preferably the web service definition includes one or more function definitions and a configuration definition. The function definition preferably provides usage instructions for an associated script or routine written in a programming language: for example (but not limited to), required parameters, expected return values, cost to execute the function. One or more programming languages may be supported. The configuration definition may set various properties of the web service such as its namespace, permissions, documentation, and/or other aspects of the web service. These definitions can exist separately or as part of a single data structure.

Namespace configuration preferably specifies, at least in part, how the web service is identified when making a request to the web service. As the web services of the FaaS platform may be globally accessible to users of the FaaS platform, the namespace is preferably globally unique within the platform.

Permission configuration can set access limits, specify usage limits, and/or set other forms of policy of the web service. Access limits may include settings such as private access, public access, authenticated accounts only, allowing a permitted listed of accounts, prohibiting list of blocked accounts, and/or other suitable forms of access limits. Access limits could additionally be specified for particular actions of the web service. For example, use of a particular function or input parameter may only be permitted for a subset of entities.

Usage limit configurations can be used to rate limit usage, place caps for different entities, or set any other form of restriction.

Documentation is preferably specified through one or more documents. This documentation can then be made available through the various interfaces used in accessing the web service. In addition to manually set documentation, analysis of the function definition may be used to derive documentation support. For example, the input parameters and the output parameters may be characterized through analysis of the function definition. In one variation, predefined semantics can be followed in the function definition to facilitate automatically generating documentation. Natural language processing or other analysis of the function definition may additionally or alternatively be used.

Web service semantics may be applied in any suitable part of a web service definition and can be used in setting instantiation and execution of the web service in block S200.

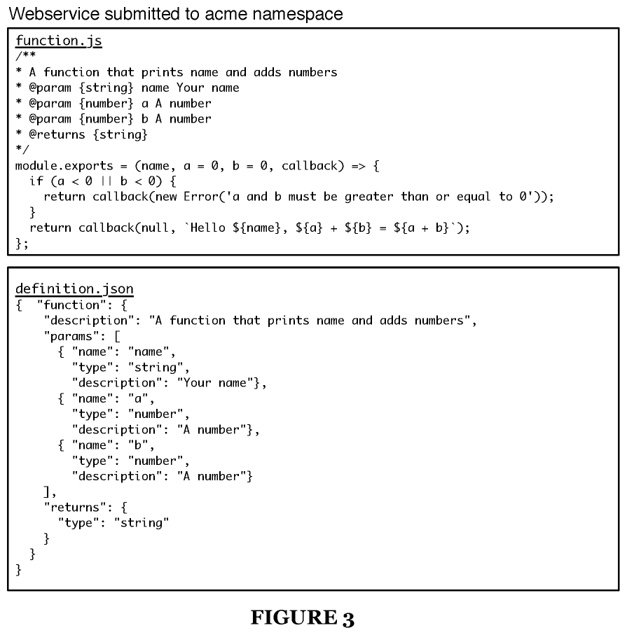

As shown in FIG. 3, a web service definition could include a JavaScript function definition file and a JSON configuration definition file. In this example, the JavaScript function is written in ES6 JavaScript and is used to generate some text result, and the JSON configuration definition file is used to set the namespace property of the web service. The configuration definition file may be manually created or edited by a developer of the web service. Alternatively, the configuration definition file may be programmatically generated or inferred by the function, function comments, or other sources. As shown in the example of FIG. 3, parameter type can be inferred through web service semantics in the comments of the function definition. For example, web service semantics of the comments in function.js may direct typechecking of the variables ‘a’ and ‘b’ so that a TypeError is returned if a non-numeric value is submitted.

The web service definition is preferably developed and submitted by an outside entity, preferably an account entity. Some set of web services may be created as first party functions of the FaaS platform. These web services may be those managed, maintained, and/or otherwise provided by the FaaS platform operator. These could be accessible in a particular namespace for easy access. In some cases, a generic web service may be used as a proxy interface to dynamically selected web services. These generic web services may be offered through the FaaS platform. For example, a mapping web service may have a generic mapping interface protocol, but the FaaS platform dynamically translates requests to the generic mapping web service into one of a set of mapping specific web services. Other web services may use other namespaces. In one implementation, the account name may be used in scoping namespace of different web services. For example, web service-A and web service-B of account X may be accessed by specifying X/web service-A.

In one variation, the web service definition is created and submitted through a function development environment offered by the FaaS platform. For example, a web IDE on a website of the FaaS platform could enable easy creation, testing, and configuration of a web service. In another variation, the web service definition can be submitted through a command line interface tool offered by the FaaS. A developer may develop the web service definition and then easily deploy the function by executing a deploy command on the command line.

Block S120, which includes processing the web service definition, functions to transform the web service definition for hosting within the platform. Processing the web service definition can include a variety of sub-processes such as a compilation and transformation sub-process, a package installation sub-process, and/or a web service registration sub-process. A compilation and transformation sub-process preferably prepares a corresponding web service for deployment within a web service infrastructure (e.g., a serverless computing environment for microservices). A package installation sub-process preferably installs packages required by the web service and required to support the programming language of the web service definition. Web service registration can include assigning id and namespace of the web service and any function calls. The various functions preferably operated in one namespace such that functions can be globally referenced by using a unique name.

Block S130, which includes instantiating a web service within a web service hosting platform, functions to setup the web service for execution through the FaaS platform. Instantiating preferably includes publishing or making accessible the web service through the FaaS platform. The web service can be made discoverable through search queries and browsing and the namespace for the web service can become active for receiving usage requests. In the case where an at least partially persistent instance of a web service is used for execution, instantiating a web service may include deploying the web service within some computing system. This preferably prepares at least one programmatic resource in a scalable computing infrastructure to handle inbound requests or events for the web service. The FaaS platform preferably uses a microservice architecture. Additionally, the computing resources can be replaceable and/or scaled. A web service instance can preferably process some volume of requests. Multiple web service instances can be deployed to scale the number of requests supported by the platform. The web service is preferably deployed as at least one web service instance, but a set of web service instances will typically make up the web service. The web service computing system can utilize computing resources directly managed by the operators of the FaaS platform but may alternatively or additionally be computing resources offered by a third party distributed computing service. In a serverless variation, web service instances are dynamically deployed on-demand to a serverless computing environment where the web service instance is instantiated, executed to handle a request, and then possibly deallocated from that computing resource. In this case, web service instances may not be proactively instantiated. In a hybrid variation, a subset web service instances can be deployed to platform managed computing resources and a second subset of web service instances may be dynamically allocated through a serverless execution environment. Any suitable computing architecture may alternatively be used.

Block S200, which includes enabling invocation of the web service for an end client, functions to enable users to consume or use the web service within their own product or service. As mentioned, one potential benefit of the system and method is that a developer can easily gain access to a wide variety of tools through a unified interface of the FaaS platform. A library of the FaaS platform may be all that a developer needs to install or include in their script, application, or product to gain access to a wide variety of APIs and function routines offered as web services.

Block S210, which includes receiving a web service function call request, functions to be prompted by a consumer of a web service to perform some action. Requests will generally be generated by a script, an application, or a service. Requests can alternatively be directly initiated by a user using one of the interfaces of the FaaS platform. The consumer of the web service may additionally be anonymous in that it may not be associated with an account. Alternatively, the consumer of the web service may authenticate with the FaaS platform so that usage is associated with a particular account.

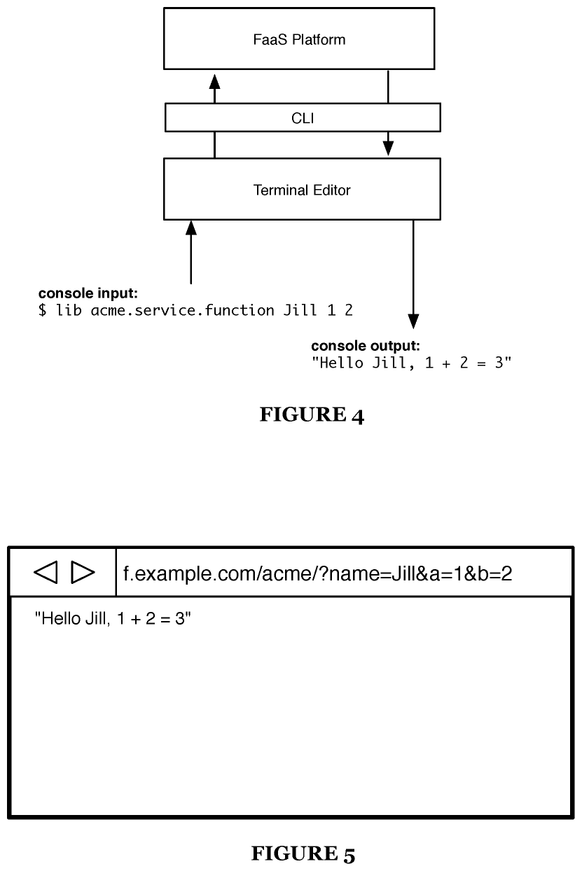

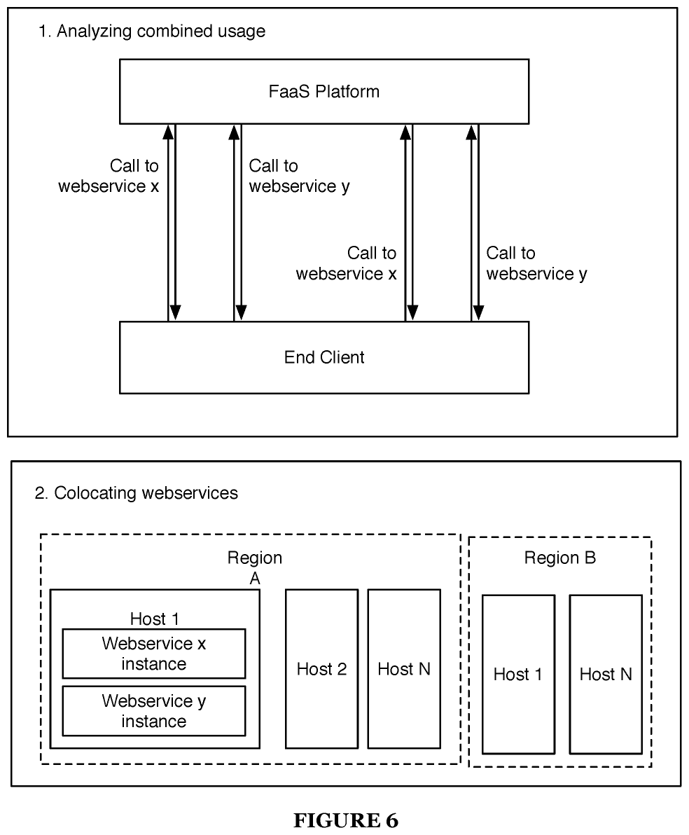

The web service function call request is preferably received over an application layer protocol and more specifically an HTTP-based protocol such as HTTP or HTTPS. The web service function call may alternatively be received over any suitable communication protocol, or a novel communication protocol optimized for FaaS execution that minimizes data transfer overhead. The web service function call request can be made through one of a set of interface options such as a command-line interface, a browser interface, an SDK interface, and/or a user application interface. In one implementation, a command-line interface can be used to call the web service function of the FaaS platform where the web service function is referenced through a namespace syntax and then various arguments, flags, verbose flags, values, and/or files can be specified. As shown in FIG. 4, the exemplary web service can be called with various inputs over the command line. The web service may alternatively be called using an alternative unified interface such as a browser as shown in FIG. 5.

Accordingly, the method may include providing a set of standard interfaces capable of receiving request. More specifically, the method can include providing a set of function call interfaces that comprise at least a command line interface, a library interface, a web browser interface, an SDK interface, a graphical user interface, and/or an API. Different web service function call requests can be received through different interfaces. In one variation, the method can include providing a web browser interface. The web browser interface may be used by any browser-enabled device. The browser interface can include graphical user interface exposed through a web application. The browser interface could additionally or alternatively include a URL formatting syntax for specifying a web service request. The result of the web service request can be returned in the webpage rendered for that URL. In another variation, the method can include providing a command line interface. A user may install a FaaS command line package to gain a simplified way of invoking various web service functions of the FaaS platform. In another variation, an SDK interface could be provided for a variety of programming environments. The SDK interface may be used when developing native applications. An application that uses the SDK will then make network requests to the FaaS platform in response to the web service usage in the application. Similarly, library interfaces may be provided. In yet another variation, an application may offer an interface through a graphical user interface. This may enable non-developers to easily perform actions through various services without needing to have knowledge of programming. In another variation, an API such as a REST API may be provided for making programmatic web service requests directly. Any suitable interface may be provided via the FaaS platform, and preferably each of these interfaces could be automatically enabled for any web service.

In connection with providing an interface for making a function call, the method may include providing manual documentation through at least one of the interfaces. For example, manual documentation for a specified web service can be accessed through the command line interface.

Similarly, the method may include providing a query interface to the set of web services. Search queries can be executed in identifying a web service matching some query parameters. In response to a web service query, the method preferably generates a set of web service query results. In one variation, a web service function call can be made in the form of a web service query, which can then trigger automatic selection of one of a set of web service query results to be used as the invoked web service. For example, a web service call may be made querying for a weather reporting web service to return the weather for a specified address. Suitable web services that matching the query properties (e.g., the web service should report weather, and accept an address as an input). The selection of the web service may be based on closest match to the query, the web service popularity ranking, and/or other factors. In one variation, web services may be able to be selectively promoted. For example, sponsored web services may be prioritized for selection due to their status over other more popular web services.

In a variation related to web service queries, the method can include providing a generic web service interface, and, when a function call is made to the generic web service interface dynamically selecting one of a set of compatible web services for processing of a function call to the generic web service. The generic web service interface preferably defines a standard format for a class of web services. For example, the FaaS platform may make a generic weather web service interface. To be a compatible web service, developers can adapt their web service interface to conform at least in part to the generic weather web service interface to become an eligible option.

Block S220, which includes processing the web service function call request, functions to determine how to handle an inbound request. Processing the request preferably includes determining routing to a function of a web service. The namespace syntax of the web service function call request is analyzed to identify a corresponding web service. Processing the request can include transforming the function call request for the function service. This may include translating the provided arguments for the web service. Type checking or inferencing, error reporting, rate limiting, authentication, and/or other aspects may be enforced at the gateway layer during the processing of the web service function call. As mentioned above, defined web service semantics may be used in the web service definition, which could translate into various forms of processing of the web service function call. Processing the request can additionally include logging analytics. Events and metadata related to usage of a function service is preferably tracked and stored in a data analytics warehousing solution.

In some instances, processing the request may invoke function help and/or search results. Usage help and documentation can be integrated so that a user can easily access documentation on how to call a particular web service. Additionally, a web service function call request may similarly request information about the web service such as a description, documentation, the name of the developer, and/or other information. In yet another variation, a web service function call request may be invalid, and processing the request can include generating automatic help and suggestions to assist the developer. As yet another variation, a web service function call request may invoke a search wherein search results of appropriate web services may be returned. Similarly, automatic selection of a web service may be performed in response to a function call that queries for a suitable web service and/or a function call to a generic web service interface.

Block S230, which includes executing the web service function call request on a web service instance, functions to execute the function within the web service computing system. Invoking the function preferably includes delivering a command to a web service instance of the function service. The web service will generate some result value, which is then returned to the requesting entity via block S240. In one variation, an instance of the web service may be previously allocated, and the function call request can be load balanced to an appropriate web service instance. In a serverless variation, a web service instance may be instantiated in a dynamic computing environment and the function call request processed by that dynamically allocated web service.

In one variation, the method may additionally include managing scaling of the web service computing system S250, which functions to orchestrate the plurality of web services in an intelligent manner. As discussed, analytics can be collected on web service usage by tracking invocation (or usage) of a web service. The analytics is preferably collected across all users and client devices. Historical models can be used to automatically manage the scaling of the web service computing system. Managing scaling of the web service can then include proactively scaling hosting of at least one web service in response to invocation history and/or usage of the web service. Managing scaling can include allocating additional web service instances of a particular web service. Additional web service instances can be allocated to handle more requests made to that web service. Managing scaling can additionally include deallocating web service instances as a form of scaling back. Web service instances of a particular web service can be deallocated when demand for a function call will be lower. Management can additionally include scaling according to temporal patterns, geographic demand patterns, usage patterns, and/or other suitable patterns. Different web service will typically follow unique usage patterns. For example, a web service for a ride sharing service may have a cyclical pattern following traffic patterns, and a web service related to annual tax returns may have a yearly cyclical pattern. The method can preferably automatically scale the web service resources to account for predicted demand. Historical trends of similar web services may also be considered in assessing patterns of a web service. Predictive modeling, machine learning, and artificial intelligence may be employed when managing the web service cloud.

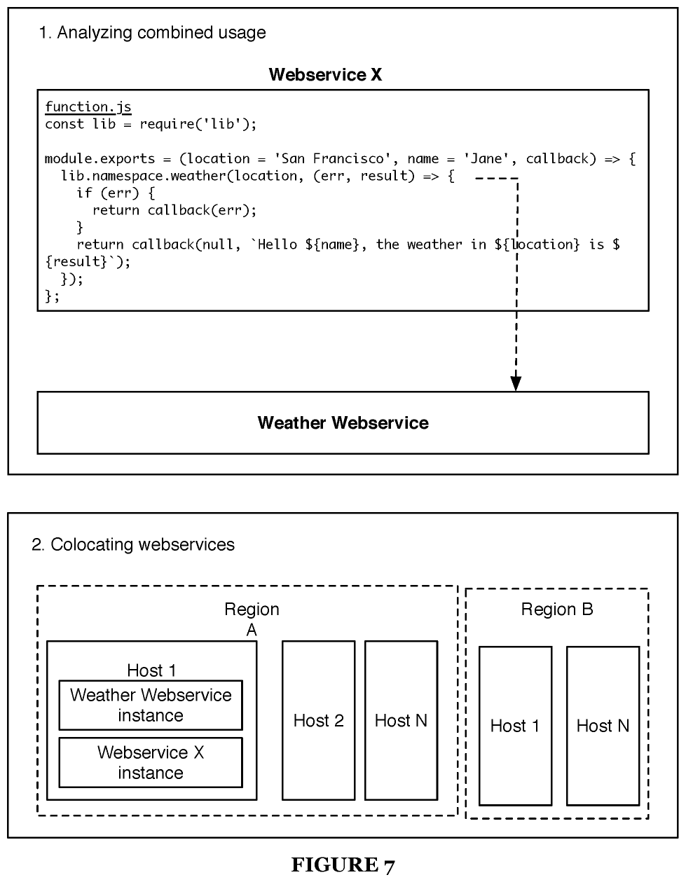

In one variation, managing scaling of web services can account for combined web service usage. Multiple web services are preferably used in combination. Accordingly, many times the use of one web service may often be accompanied by usage of one or more other web services. In variation relating to external combined usage, an outside web service will generally use multiple web services of the FaaS platform as shown in FIG. 6. Furthermore, the method may include tracking the set of web services used by a particular end client (e.g., an application, a service, script, etc.) and/or user account. For example, a weather-based web app may make use of a weather data web service and a mapping web service. As another example, a user account may have a set of web services that are often used when interacting with the CLI of the FaaS platform. Combined usage of at least two web services can be assessed or determined based on temporal proximity (e.g., probability of being used within short time intervals), usage patterns (e.g., do certain properties of usage of one web service indicate different probabilities of use of another web service), and/or other patterns of usage. For example, two web services may be determined to have combined usage in association with a first account because of temporal proximity of invocation by that account—when the account uses one web service it usually uses a second. In one variation, such combined usage analysis may be facilitated through machine learning across a number of contributing features.

In another variation, a web service hosted in the FaaS platform may call one or more web services as part of its execution logic as shown in FIG. 7. Analysis of a web service may first identify the set of web services used by the first web service and then optionally determining the probability of usage of any one of the set of web services. Such analysis may be recursive in that the use of one web service may trigger the use of another web service, which then uses yet another web service and so on. Analysis of internal web service usage may use semantic interpretation of the logic of a web service and/or tracking usage of the web service (similar to the external tracking of combined usage above).

Managing scaling of the web service can then include architecting deployment of the first and second web services based on the combined usage of the first web service and at least a second web service. This can be based on determined probability or assessed combined usage. Preferably, architecting deployment of web services with combined usage will result in collocating web service instances geographically (e.g., in the same data center), with respect to network topology (e.g., accessible over private network without use of public network), and/or with respect to computing device (e.g., web services hosted on the same computing device for avoiding network usage). Accordingly, invocation of a first web service may trigger the coordinated invocation of the second web service.

The tracked usage may additionally be used in limiting usage and/or billing for usage of a web service. Billing for a web service will preferably include setting usage billing configuration in the web service resource definition. A creator of a web service can preferably customize various aspects of billing such as how usage is billed (e.g., by volume, per request, flat rate, etc.), the billing rates, billing tiers or plans, and/or other billing patterns. Accordingly, tracking invocation of a web service will include tracking usage for individual accounts and generating a billing report according to usage of the individual accounts and the billing configuration. In this way billing could be automatically enabled and enforces, freeing the creator of the web service from managing billing logistics. Furthermore, billing for the end user accounts can combine the billed usage for a set of web services used by the account. In this way users could easily pay for different web services without needing to manage multiple different accounts and payment plans.

As another variation, the method may enable a web service provider to configure a function service for caching. A web service that is substantially static could benefit from caching results. Accordingly, the method may include caching a response to a function call and returning the cached response to subsequent function calls corresponding to the function call. Corresponding function calls are preferably those made to the same web service and with matching or equivalent input parameters. In one variation, caching may be an option enabled through the web service configuration. A creator of the web service may best understand if a web service is suitable for webcaching and enable a caching option. Alternatively, automatic caching may be used by the FaaS platform. In automatic caching, the FaaS platform monitors usage of the web service and determines if the web service is classified as a cacheable. Alternatively, the method may include analyzing logic of the web service to interpret the cacheability of results of a web service. Furthermore, only results for particular function calls may be cached and used. The method could additionally enable other performance enhancements and optimizations.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method comprising:
creating a set of distinct web services within a web service hosting platform, the set of web services created by a set of distinct accounts, and the creation of a web service comprising:
receiving a web service resource definition,
processing the web service resource definition, and
instantiating a web service of the web service resource definition within the web service hosting platform; and
invoking of a web service instantiated in the web service hosting platform for a client device, wherein responsive to an invocation is a process comprising:
receiving a web service function call request,
executing the web service function call request on a web service instance, and
responding to the web service function call request with a result of the web service.

2. The method of claim 1, further comprising providing a set of function call interfaces that comprise at least a command line interface and a library interface; and wherein the web service function call request is received through at least one of the set of function call interfaces.

3. The method of claim 1, further comprising providing a set of function call interfaces that comprises at least a command line interface; and wherein the web service function call request is received through at least one of the set of function call interfaces.

4. The method of claim 3, further comprising providing manual documentation through the command line interface to the set of web services of the web service hosting platform.

5. The method of claim 1, further comprising providing a query interface to the set of web services, which comprises generating a set of webserver query results in response to a web service query.

6. The method of claim 5, wherein the web service function call is made in the form of a web service query; and further comprising automatically selecting one of the set of web service query results as the invoked web service used in executing the function call.

7. The method of claim 6, wherein selecting one of the set of web service query results selects the invoked web service at least partially based on web service popularity ranking.

8. The method of claim 1, further comprising tracking usage of the web services.

9. The method of claim 8, further comprising proactively scaling web service instances of at least one web service in response to usage of the web service.

10. The method of claim 8, further comprising architecting deployment of a set of web services used in combination in response to tracked usage of the web services.

11. The method of claim 8, wherein the web service resource definition comprises usage billing configuration; wherein tracking usage of the web service comprises tracking usage by a second account; and further comprising generating a billing report according to usage of the second account and the usage billing configuration.

12. The method of claim 1, further comprising analyzing combined usage of a first web service and a second web service; and architecting deployment of the first and second web services based on the combined usage of the first web service and the second web service.

13. The method of claim 12, wherein combined usage is determined by temporal proximity of invocation by an account instance.

14. The method of claim 12, wherein combined usage is determined through detecting usage of at least a second web service by a first web service; and wherein architecting deployment can comprise automatically instantiating an instance of the second web service in coordination with instantiation of an instance of the first web service.

15. The method of claim 14, wherein instantiating an instance of the second web service in coordination with instantiation of an instance of the first web service comprises colocating instances of the first and second web service.

16. The method of claim 1, further comprising caching a response to a function call and returning the cached response to second corresponding function call.

17. The method of claim 1, further comprising providing a generic interface to a set of web services; and when the web service function call request is to the generic interface, dynamically selecting one of a set of compatible web services for use in executing the function call.

18. The method of claim 1, wherein the web service resource definition includes a function definition and configuration definition.

19. The method of claim 18, wherein configuration definition can include namespace configuration, permissions, usage limits, and documentation.

20. A system for a function-as-a-service platform comprising:
a web service management system configured to:
receive a web service resource definition,
process the web service resource definition, and
instantiate a web service of the web service resource definition within the function-as-a-service platform;
a platform interface gateway configured to:
receive a web service function call request,
execute the web service function call request on a web service instance, and
respond to the web service function call request with a result of the web service; and
an infrastructure management system configured to scale web service instances based in part on usage of web services through the platform interface gateway.
